(19) United States
(12) Patent Application Publication
(10) Pub. No.: US 2018/0183283 A1
(43) Pub. Date: Jun. 28, 2018

(54) HERMETICALLY SEALED ELECTROMAGNETIC STATOR

(71) Applicant: CUMMINS INC., Columbus, IN (US)

(72) Inventors: Michael A. Lucas, Columbus, IN (US); David M. Rix, Columbus, IN (US); Edward B. Manring, Edinburgh, IN (US); Yogesh G. Datar, Columbus, IN (US); Madeline J. Sullivan, Columbus, IN (US)

(21) Appl. No.: 15/852,289

(22) Filed: Dec. 22, 2017

Related U.S. Application Data
(60) Provisional application No. 62/437,932, filed on Dec. 22, 2016.

(51) Int. Cl. H02K 1/18; H02K 15/02

(52) U.S. Cl. CPC H02K 1/187; H02K 15/02

(57) ABSTRACT

A stator assembly comprising: a stator having an inner diameter; a plurality of coils wrapped around the stator; and a seal plate positioned on the lower surface of the stator and spanning the inner diameter of the stator, the seal plate having at least one welded edge to form a hermetic seal along the stator.

### CROSS REFERENCE TO RELATED APPLICATION

This application claims the benefit under Title 35, U.S.C. § 119(e) of U.S. Provisional Patent Application Ser. No. 62/437,932, entitled HERMETICALLY SEALED ELECTROMAGNETIC STATOR and filed on Dec. 22, 2016, the entire disclosure of which is hereby expressly incorporated by reference herein

### FIELD OF THE DISCLOSURE

The present invention relates generally to electromagnetic stators and, more particularly, to a hermetically sealed electromagnetic stator.

### BACKGROUND OF THE DISCLOSURE

Electromagnetic stators can be used with fuel injectors to introduce fuel into the cylinders of an internal combustion engine. When a fuel source is electrically conductive (e.g., ethanol or ED95), fluid in both vapor and liquid form may be present in the interior of a potted or molded stator assembly and can provide an electrically conductive path from the stator coil wires to outside metal parts of the stator. Although the wires are coated with a film that acts as an electrical insulator, cracks in the film can lead to direct electrical connections resulting in electrical shorting. Also, even if the insulating film is intact, hipot failure via dielectric breakdown can occur causing fault circuitry to be triggered in an electric control module, which could shut down the injector bank on which the hipot or direct short circuit failure occurs. Electrical shorting of the stator/fuel injector may also reduce the life of the stator/fuel injector. As such, one aspect of fuel supply systems that has been the focus of designers is the need to produce alternative stator designs that mitigate or prevent the occurrence of electrical shorting while maintaining proper functionality.

### SUMMARY OF THE DISCLOSURE

The various aspects of the present disclosure may be achieved by providing a thin seal plate to hermetically seal an electromagnetic stator. In one embodiment of the disclosure, a stator assembly comprises: a stator having an inner diameter; a plurality of coils wrapped around the stator; and a seal plate positioned on the lower surface of the stator and spanning the inner diameter of the stator, the seal plate having at least one welded edge to form a hermetic seal along the stator.

According to one embodiment, a stator assembly is provided. The stator assembly comprising: a stator having an inner diameter; a plurality of coil windings wrapped around the stator; and a seal plate positioned on the lower surface of the stator and at least partially surrounding the inner diameter of the stator, the seal plate having at least one welded edge to form a hermetic seal along the stator. In another embodiment, the seal plate has a thickness of at least 50 μm. In a further embodiment, the seal plate has a thickness of 100 μm. In yet another embodiment, the edge is welded onto the stator by a laser. In another embodiment, the stator assembly further comprising an armature positioned below the lower surface of the stator, wherein the armature moves upward when electrical current is sent through the coil windings. In another embodiment, the stator assembly further comprising a solenoid encompassing the plurality of coil windings, the solenoid having the characteristics of an electromagnet when current is sent through the coil windings to attract the armature. In yet another embodiment, the seal plate is made of a magnetic alloy. In another embodiment, the seal plate is made of low carbon steel. In another embodiment, the hermetic seal provided by the at least one welded edge is thin enough to limit flux leakage between magnetic poles.

According to another embodiment, a stator assembly is provided. The stator assembly comprising: a stator; a plurality of coil windings wrapped around the stator; a solenoid encompassing the plurality of coil windings; and a seal plate positioned on the lower surface of the stator and at least partially surrounding the inner diameter of the stator, the seal plate having at least one welded edge to form a hermetic seal along the stator; wherein the hermetic seal seals the plurality of coil windings within the solenoid; and wherein the hermetic seal is between a first ferritic alloy and a second ferritic alloy. In another embodiment, the seal plate is made of low carbon steel. In a further embodiment, the seal plate is made of a magnetic alloy. In another embodiment, the hermetic seal provided by the at least one welded edge is thin enough to limit flux leakage between magnetic poles. In yet another embodiment, the seal plate has a thickness of at least 50 μm. In a further embodiment, the seal plate has a thickness of 100 μm. In yet another embodiment, the edge is welded onto the stator by a laser.

According to another embodiment, a method of assembling a stator assembly is provided. The method of assembling a stator assembly including: providing a stator, wherein the stator includes: a plurality of coil windings wrapped around the stator; and a seal plate positioned on the lower surface of the stator and at least partially surrounding an inner diameter of the stator, and welding at least one edge of the seal plate onto the stator assembly to form a hermetic seal along the stator, wherein the seal plate has a thickness of at least 50 μm and the hermetic seal provided by the at least one welded edge is thin enough to limit flux leakage between magnetic poles. In one embodiment, the seal plate has a thickness of 100 μm. In a further embodiment, the edge is welded onto the stator by a laser. In another embodiment, the seal plate is made of a magnetic alloy.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a cross-sectional view of an electromagnetic stator in accordance with the present disclosure;

FIG. 2 is perspective view of the lower portion of the electromagnetic stator of FIG. 1;

FIG. 3 is a front perspective view of a stator cap in accordance with the present disclosure;

FIG. 4 is a cross-sectional view of an electromagnetic stator in accordance with the present disclosure;

FIG. 5 is a graph illustrating magnetic flux leakage of the electromagnetic stator;

FIG. 6 is a graph illustrating the force characteristics of the electromagnetic stator of FIG. 5 in relation to seal plate thickness of the electromagnetic stator; and

FIG. 7 is a graph illustrating the delayed force, current, and displacement of the stator of FIG. 1 based on the thickness of the seal plate used on the electromagnetic stator.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

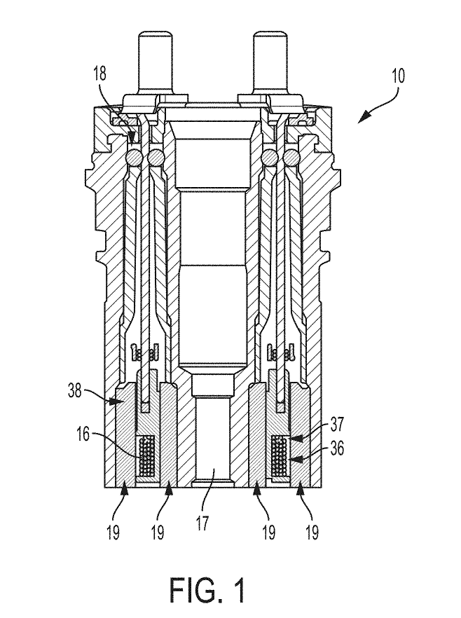

Referring to FIGS. 1-4, an electromagnetic stator assembly 10 is shown. Electromagnetic stator assembly 10 includes a plurality of coil windings 16 and potting material 36 in an interstitial region 37 between coil windings 16 and stator core 38. Stator assembly 10 further includes a bore 17 configured for the accommodation of a plunger (not shown) to guide an armature 20. In the illustrated embodiment, coil windings 16 may be made from copper. However, it is contemplated that in other alternate embodiments, other suitable electrically conductive materials may be used. In the illustrated embodiment, potting material 36 may be comprised of thermoset epoxy or thermoplastic materials. However, it is contemplated that in other alternate embodiments, other suitable materials may be used, such as epoxy-novolac based thermosets that have high glass transition temperatures.

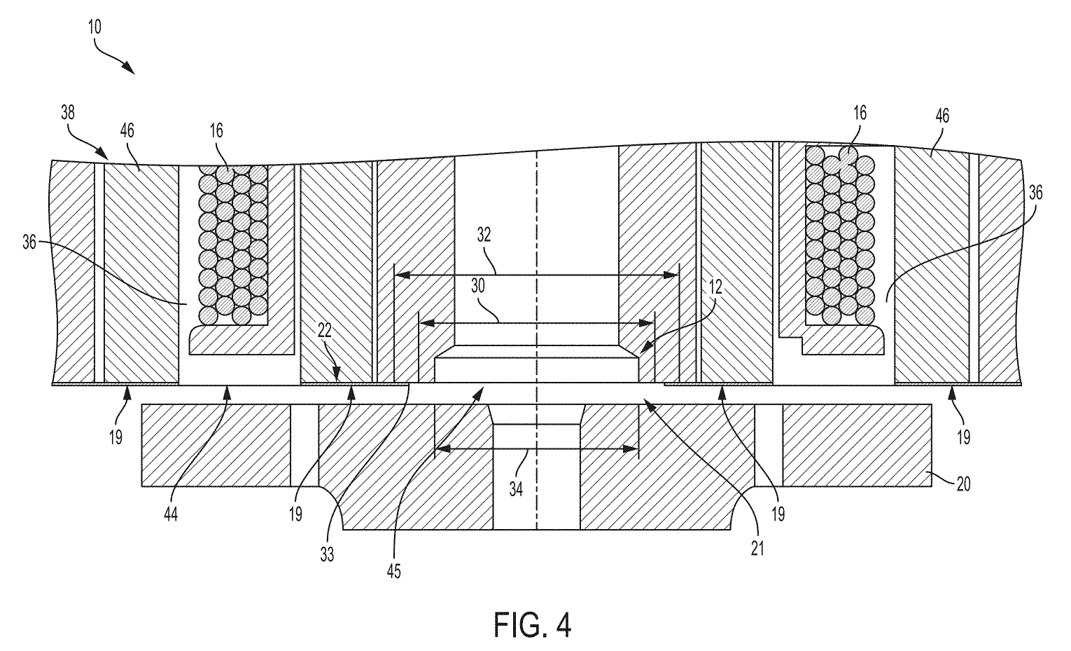

Stator assembly 10 is positioned above an armature 20 (FIG. 4) such that a stroke gap 45 exists between stator assembly 10 and armature 20. FIG. 4 shows a stator assembly 10 having an inner diameter 34 and no stroke gap. Inner diameter 34 may be as little as 5.25 mm, 5.35 mm, 5.37 mm, or as great as 5.4 mm, 5.45 mm, 5.5 mm or within any range defined there between such as 5.35 mm to 5.45 mm. Armature 20 has an outer diameter 30 that defines an armature impact zone. Outer diameter 30 may be as little as 6 mm, 6.175 mm, 6.225 mm or as great 6.275 mm, 6.325 mm, 6.5 mm or within any range defined there between such as 6.175 mm to 6.375 mm.

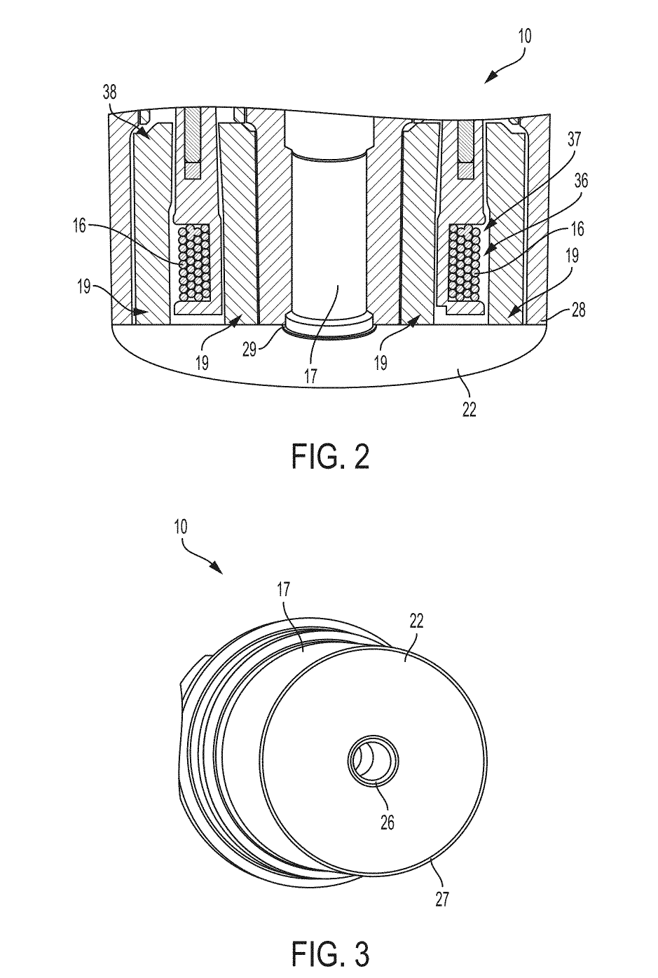

As shown in FIGS. 2 and 3, stator assembly 10 includes a seal plate 22. Seal plate 22 is coupled to lower surface 33 (FIG. 4) of stator assembly 10 and surrounds the inner diameter 34 (FIG. 4) of stator assembly 10. Seal plate 22 has a weld inner diameter 32 that may be as little as 7.325 mm, 7.425 mm, 7.525 mm or as great as 7.625 mm, 7.725 mm, 7.825 mm, or within any range defined between any of the foregoing values, such as 7.325 mm to 7.825 mm. Seal plate 22 further includes welded edges 26, 27, 28, and 29. Edges 26, 27, 28, and 29 are laser welded onto stator assembly 10 such that seal plate 22 forms a hermetic seal on stator assembly 10. In alternate embodiments, capacitive discharge welding may be used to weld edges 26, 27, 28, 29. In the illustrated embodiment, seal plate 22 is welded onto solenoid 46 to create a hermetic seal that functions to seal coil windings 16 within solenoid 46 while also preserving the electromagnetic function of stator assembly 10.

Laser welding edges 26-29 onto stator assembly 10 creates hermetic seal over a face of stator assembly 10 using a minimal number of parts required to achieve a desired sealing effect. Alternate sealing methods (e.g., an O-ring and a pressure joint) could be used to create the seal; however, such alternate sealing methods require additional parts or components and more space (i.e., these methods are more expensive and less efficient with their use of space). Moreover, by creating a hermetic seal over a face of stator assembly 10 rather than within a joint, the overall size of stator assembly 10 of stator assembly 10 can be increased.

The hermetic seal formed by seal plate 22 and the corresponding laser welded edges 26-29 prevent fuel from entering the interior of stator assembly 10. In the illustrated embodiment, seal plate 22 is made of a low carbon steel. However, it is contemplated that in alternate embodiments seal plate 22 is made of a ferritic alloy. As mentioned earlier, the hermetic seal functions to seal coil windings 16 within solenoid 46 while preserving the electromagnetic function of stator assembly 10. In one embodiment, the hermetic seal between stator assembly 10 and seal plate 22 involves a seal between two ferritic alloys. In one embodiment, the ferritic alloys are the same alloy. In an alternate embodiment, the ferritic alloys are different alloys. However, it is contemplated that in alternate embodiments, other suitable materials may be used such as non-austenitic stainless steel or other suitable magnetic materials. The magnetic nature of the seal plate material reduces reluctance between stator poles 19 and armature 20 as compared to a non-magnetic seal plate, increasing the force achievable by stator assembly 10.

As discussed below, the thickness of seal plate 22 affects flux leakage between stator poles 19 of stator assembly 10. In some embodiments, the thickness of seal plate 22 may be as little as 50 μm or as great as 500 μm or more. In an exemplary embodiment, the thickness of seal plate 22 is 100 μm.

During operation of stator assembly 10, coil windings 16 are energized. When coil windings 16 are energized, solenoid 46 acts as an electromagnet which causes armature 20 to move upward under magnetic attraction to solenoid 46. As armature 20 moves upward, a contacting portion 21 of armature 20 contacts lower surface 33 of stator assembly 10 at contact region 12, opening the injector pilot valve. Conversely, when coil windings 16 are de-energized, solenoid 46 and armature 20 are no longer magnetically attracted to each other and armature 20 moves downwardly from stator assembly 10 disengaging from stator assembly 10.

The presence of seal plate 22 and the corresponding laser welded edges 26, 27, 28, and 29 offer some advantageous properties. One feature is that the hermetic seal created by the seal plate prevents electrically conductive fuel (e.g., ethanol or ED95) from entering electromagnetic stator assembly 10. Electrically conductive fuel entering electromagnetic stator assembly 10 can provide an electrical path from coil windings 16 to other steel parts of stator assembly 10 thereby, shorting windings 16 or terminals 18 to ground. Additionally, fuel or vapor entering stator assembly 10 may be absorbed by potting material 36 such that potting material 36 swells, fills air gap 44 and contacts armature 20, resulting in limited vertical movement of armature 20 during operation. In other words, by hermetically sealing stator assembly 10 from fuel or fuel vapors, air gap 44 remains intact and armature 20 is able to move vertically and operate accordingly.

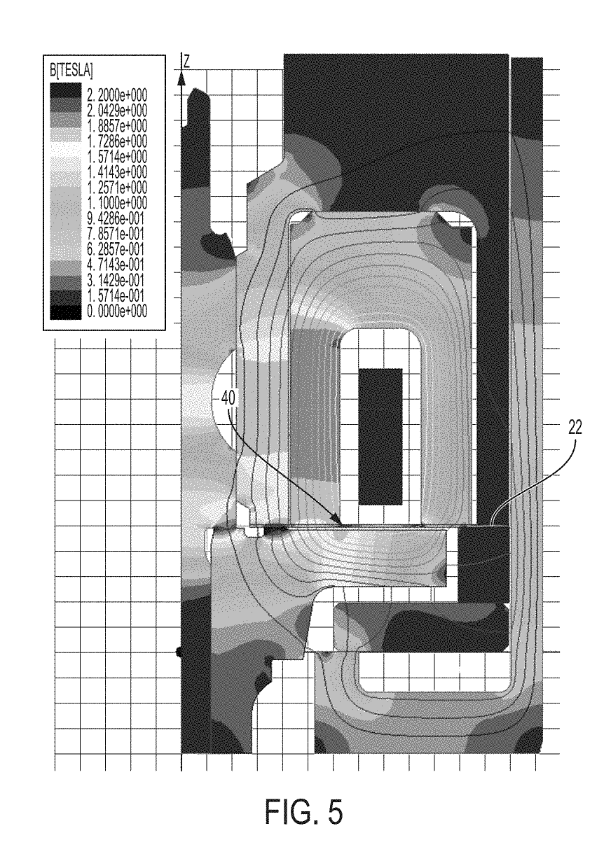

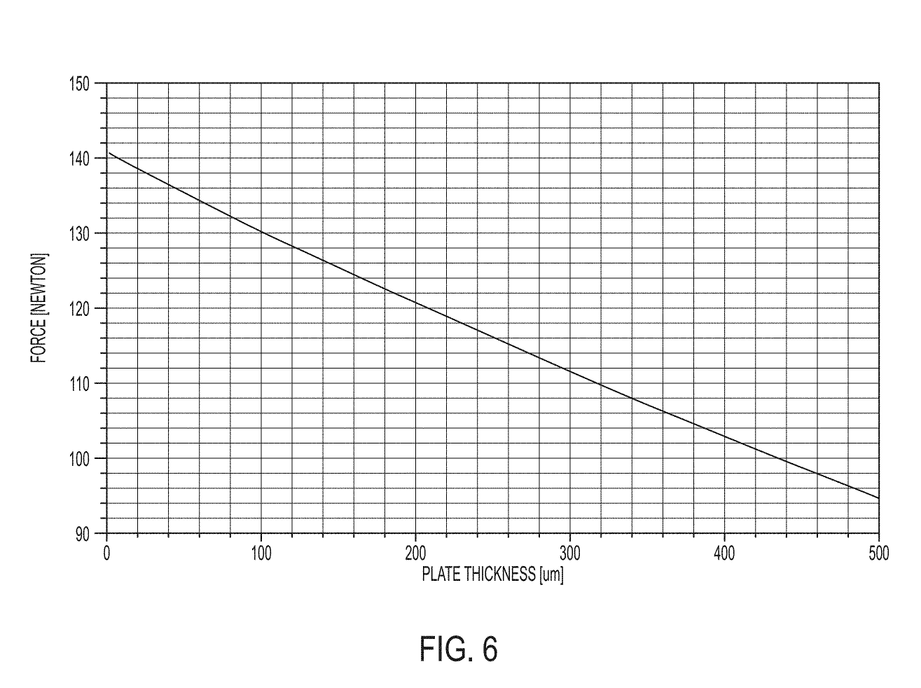

FIG. 5 shows a magnetic flux diagram for stator assembly 10 with seal plate 22 having a thickness of 100 μm. As shown in FIG. 5, with a seal plate 22, the magnetic flux saturates around region 40 and flux leakage between stator poles 19 of stator assembly 10 is limited. A thicker plate increases magnetic flux leakage causing a reduction in armature force as discussed further herein with respect to FIG. 6. Conversely, a thinner seal plate decreases magnetic flux leakage; however, a seal plate that is too thin may structurally fail during operation of stator assembly 10.

Magnetic flux leakage is maximally limited if a non-magnetic plate is used; however, the magnetic force on armature 20 in such case would be reduced significantly resulting in effectively increasing the air gap between armature 20 and stator assembly 10 by the thickness of seal plate 22.

FIG. 6 shows a graph relating force applied to armature 20 to the thickness of the seal plate used in hermetically sealed stator assembly 10. As can be seen in FIG. 6, as the seal plate thickness increases, the force applied on armature 20 decreases due increasing flux leakage between stator poles 19 (shown in at least FIG. 1).

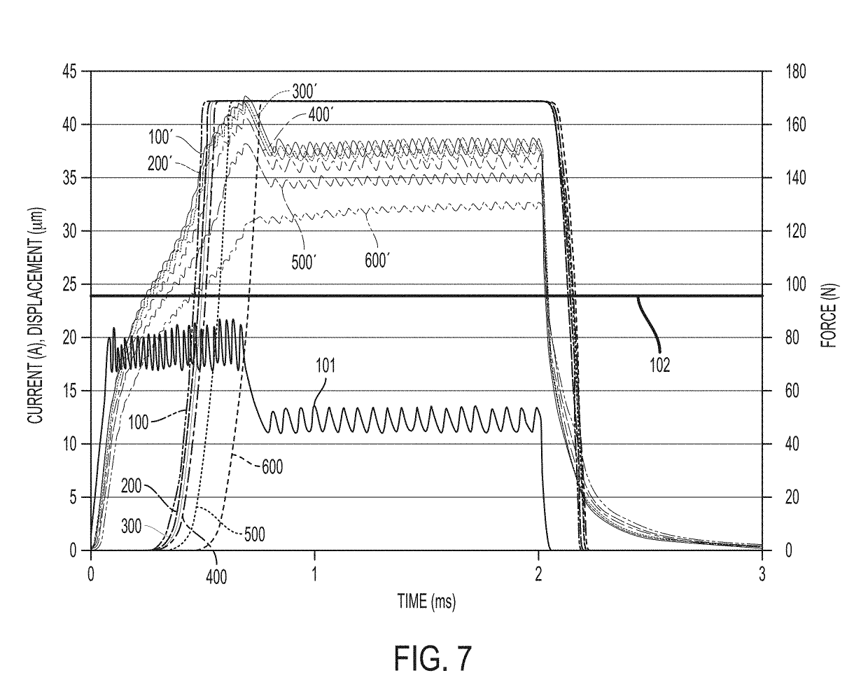

FIG. 7 shows transient analysis of stator assembly 10 and armature 20. Force applied by armature 20 and displacement of armature 20 are shown versus current on-time for various seal plate thicknesses. The data shown in FIG. 7 represent stator assemblies that include a preloaded spring (not shown) applying 500 bar on a check ball (not shown) of the fuel injector as shown in curve 102, and a current flowing through coil windings 16 as shown in curve 101. For armature displacement, curves 100, 200, 300, 400, 500, and 600 correspond to a baseline where no seal plate is used, a 10 μm thick seal plate 22 is used, a 25 μm thick seal plate 22 is used, a 50 μm thick seal plate 22 is used, a 100 μm thick seal plate 22 is used, and a 200 μm thick seal plate 22 is used, respectively. As can be seen, a greater time delay in displacing armature 20 a specified distance occurs as the thickness of the metal plate is increased. For a 100 μm thick seal plate 22, a time delay of 100 μs is experienced to displace armature 20.

For the force applied by armature 20, curves 100′, 200′, 300′, 400′, 500′, and 600′ correspond to a baseline where no seal plate is used, a 10 μm thick seal plate 22 is used, a 25 μm thick seal plate 22 is used, a 50 μm thick seal plate 22 is used, a 100 μm thick seal plate 22 is used, and a 200 μm thick seal plate 22 is used, respectively. As shown by the data in FIG. 7, a greater time delay for the application of maximum force by armature 20 occurs in stator assembly 10 as the thickness of seal plate 22 increases. Additionally, a reduced maximum force applied by armature 20 also occurs as the thickness of seal plate 22 increases as shown in FIG. 7. For a 100 μm thick seal plate 22, a time delay of 100 μs is experienced for armature 20 to apply a maximum force.

The time delay for armature displacement and maximum force application by armature 20 in addition to the time delay for reduced maximum force of armature 20 occur because there is increased flux leakage between poles 19 of stator assembly 10 as the thickness of seal plate 22 increases. Additionally, thicker seal plates 22 more readily conduct eddy currents, which have the effect of opposing changes in flux and force.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A stator assembly comprising:
a stator having an inner diameter;
a plurality of coil windings wrapped around the stator; and
a seal plate positioned on the lower surface of the stator and at least partially surrounding the inner diameter of the stator, the seal plate having at least one welded edge to form a hermetic seal along the stator.

2. The stator assembly of claim 1, wherein the seal plate has a thickness of at least 50 μm.

3. The stator assembly of claim 1, wherein the seal plate has a thickness of 100 μm.

4. The stator assembly of claim 1, wherein the edge is welded onto the stator by a laser.

5. The stator assembly of claim 1, further comprising an armature positioned below the lower surface of the stator, wherein the armature moves upward when electrical current is sent through the coil windings.

6. The stator assembly of claim 5, further comprising a solenoid encompassing the plurality of coil windings, the solenoid having the characteristics of an electromagnet when current is sent through the coil windings to attract the armature.

7. The stator assembly of claim 1, wherein the seal plate is made of a magnetic alloy.

8. The stator assembly of claim 1, wherein the seal plate is made of low carbon steel.

9. The stator assembly of claim 1, wherein the hermetic seal provided by the at least one welded edge is thin enough to limit flux leakage between magnetic poles.

10. A stator assembly comprising:
a stator;
a plurality of coil windings wrapped around the stator;
a solenoid encompassing the plurality of coil windings; and
a seal plate positioned on the lower surface of the stator and at least partially surrounding the inner diameter of the stator, the seal plate having at least one welded edge to form a hermetic seal along the stator;
wherein the hermetic seal seals the plurality of coil windings within the solenoid; and
wherein the hermetic seal is between a first ferritic alloy and a second ferritic alloy.

11. The stator assembly of claim 10, wherein the seal plate is made of low carbon steel.

12. The stator assembly of claim 10, wherein the seal plate is made of a magnetic alloy.

13. The stator assembly of claim 10, wherein the hermetic seal provided by the at least one welded edge is thin enough to limit flux leakage between magnetic poles.

14. The stator assembly of claim 13, wherein the seal plate has a thickness of at least 50 μm.

15. The stator assembly of claim 14, wherein the seal plate has a thickness of 100 μm.

16. The stator assembly of claim 15, wherein the edge is welded onto the stator by a laser.

17. A method of assembling a stator assembly including:
providing a stator, wherein the stator includes:
a plurality of coil windings wrapped around the stator; and
a seal plate positioned on the lower surface of the stator and at least partially surrounding an inner diameter of the stator, and
welding at least one edge of the seal plate onto the stator assembly to form a hermetic seal along the stator, wherein the seal plate has a thickness of at least 50 μm and the hermetic seal provided by the at least one welded edge is thin enough to limit flux leakage between magnetic poles.

18. The method of claim 17, wherein the seal plate has a thickness of 100 μm.

19. The method of claim 17, wherein the edge is welded onto the stator by a laser.

20. The method of claim 17, wherein the seal plate is made of a magnetic alloy.
